(19) United States
(12) Patent Application Publication
(10) Pub. No.: US 2007/0149196 A1
(43) Pub. Date: Jun. 28, 2007

(54) Handover reestablishment method of communication system

(75) Inventors: Yong-Seouk Choi, Daejeon city (KR); June-Bae Seo, Gunpo-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/635,111

(22) Filed: Dec. 7, 2006

(30) Foreign Application Priority Data
Dec. 8, 2005 (KR) 10-2005-0119920

(51) Int. Cl. H04Q 7/20

(52) U.S. Cl. 455/436

(57) ABSTRACT

A handover reestablishment method capable of effectively re-accessing the serving base station when the mobile terminal fails ranging while moving to the target cell and performs ranging through the handover process, or when the direction of the mobile terminal is changed and thus, the mobile terminal enters into the serving area, is provided. The method includes receiving a handover request message from the mobile terminal; waiting without canceling a connection to the mobile terminal when receiving the handover request message; and performing a reconnection with the mobile terminal when receiving a handover reconnection message from the mobile terminal.

### PRIORITY

This application claims priority under 35 U.S.C. §119 to a Korean application filed in the Korean Intellectual Property office on Dec. 8, 2005 and allocated Serial No. 10-2005-0119920, the content of which is incorporated herein by reference.

### BACKGROUND OF THE INVENTION

1. Field of the Invention

The present invention relates to a handover reestablishment method of a communication system, and more particularly, to a handover reestablishment method between a mobile terminal and a serving base station when the handover has failed in a portable Internet system.

2. Description of the Related Art

A communication system such as IEEE 802.16-based portable Internet system supports a handover process so as to ensure the mobility of the mobile terminal. The term “handover process” means that the mobile terminal is automatically synchronized to a new channel when the mobile terminal moves out of the service state from the present service cell boundary into a different service cell boundary in order to continuously maintain a service state.

The cell boundary area is where the handover process is performed according to the mobility of the mobile terminal. Under the cell boundary environment, the mobile terminal receives interferences from various neighboring base stations due to characteristics of the cell boundary environment. Presently, the intensity of a signal received from the base stations is not strong. In particular, since the portable Internet system defines the moving speed of the mobile terminal as much as 60 Km, it requires a more delicate handover process.

In the communication system such as the portable Internet system, the handover process may not be performed in a Make Before Break (MBB) manner. That is, according to the handover process, the mobile terminal cancels the connection with the serving base station and then starts a connection with the target base station. The handover occurs in the cell boundary and the moving direction of the mobile terminal is often irregular.

In this case, an error may be generated while ranging is performed so that the mobile terminal is connected with the target base station in the target area. For example, when the moving direction of the mobile terminal is changed, the mobile terminal may need reconnection with the serving base station.

However, since the conventional communication system uses the handover process in which the connection between the mobile terminal and the serving base station is cancelled and then a connection between the mobile terminal and the target base station is tried, the mobile terminal tries a connection with the serving base station through a newly signaling process when the mobile terminal is reconnected with the serving base station. Such a Ping-Pong phenomenon may often occur in the cell boundary.

According to the conventional communication system, the handover process cannot be normally performed because the connection between the mobile terminal and the serving base station is cancelled without checking connection of the mobile terminal in the target area.

### SUMMARY OF THE INVENTION

The present invention provides a handover reestablishment method for effectively reconnecting a mobile terminal with a serving base station when the mobile terminal fails ranging while moving to the target cell and then performs ranging though the handover function.

In addition, the present invention provides a handover reestablishment method having the advantages of effectively reconnecting a mobile terminal with a serving base station when the direction of the mobile terminal is changed and thus, the mobile terminal enters into the given serving area.

The present invention provides a method for reestablishing a handover with a handover-performing mobile terminal in a serving base station when the mobile terminal fails to perform the handover with a target base station. The handover reestablishment method includes receiving a handover request message from the mobile terminal;

waiting without canceling the connection to the mobile terminal when receiving the handover request message; and

performing a reconnection with the mobile terminal when receiving a handover reconnection message from the mobile terminal.

On performing the reconnection, the serving base station may perform a real-time reconnection with the mobile terminal without any additional signaling process.

The reconnection process may include receiving the handover reconnection message from the mobile terminal, and

performing reconnection with the mobile terminal while the serving base station receiving the handover reconnection message is waiting for the connection cancellation.

The serving base station may perform the reconnection with the mobile terminal using a parameter included in the handover instruction message.

The handover instruction message “HO-IND” may include a reconnect parameter.

The present invention further provides a method for reestablishing handover with a handover-performing mobile terminal in a serving base station. The method includes receiving a handover request message from the mobile terminal;

waiting without canceling the connection with the mobile terminal when receiving the handover request message;

receiving a backbone message including a ranging result from the target base station performing the ranging process with the mobile terminal; and,

reconnecting with the mobile terminal when receiving a handover reconnection message from the mobile terminal.

Receiving the backbone message may include canceling the connection to the mobile terminal when the ranging result of the backbone message is a success.

Receiving the backbone message includes waiting for the connection cancellation when the ranging result of the backbone message fails.

The method further includes canceling the connection to the mobile terminal when receiving no message for the ranging result from the target base station within a predetermined time and also when receiving no message for the reconnection from the mobile terminal.

### BRIEF DESCRIPTION OF THE DRAWINGS

The above and other objects, features and advantages of the present invention will become more apparent from the following detailed description of the preferred embodiments of the present invention, taken in conjunction with:

FIG. 1 schematically illustrates a handover occurring in a portable Internet network according to an exemplary embodiment of the present invention;

FIG. 2 is a block diagram of a handover reestablishment apparatus according to the exemplary embodiment of the present invention;

FIG. 3 is a flowchart of how to re-establish a handover in a portable Internet system according to the exemplary embodiment of the present invention;

FIG. 4 is a flowchart of how to handover-reconnect a mobile terminal and a serving base station in a general portable Internet system;

FIG. 5 is a flowchart of how to handover-reconnect a mobile terminal and a serving base station in a portable Internet system according to the exemplary embodiment of the present invention;

FIG. 6 is a flowchart of how to handover-reconnect a mobile terminal and a serving base station in a portable Internet system according to the exemplary embodiment of the present invention;

FIG. 7 is a flowchart of how to perform a ranging between a mobile terminal and a target base station on a handover according to the exemplary embodiment of the present invention.

### DETAILED DESCRIPTION OF THE EMBODIMENTS

As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Hereinafter, a handover reestablishment method according to an exemplary embodiment of the present invention will hereinafter be described in detail with reference to the accompanying drawings.

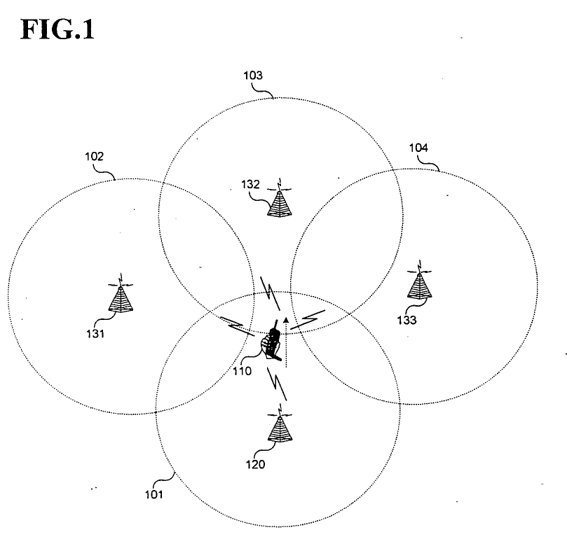

Referring to FIG. 1, in the portable Internet network, a mobile terminal 110 connected to a serving base station 120 is moved from one serving cell 101 to another cell, and accordingly, a handover may occur.

The mobile terminal 110 gathers information of the target base station 131, 132, and 133 covering each cell 102, 103, and 104, and monitors a radio channel state of the target base station 131, 132, and 133 by scanning means.

Consecutively, the mobile terminal 110 selects the target base station capable of providing a service of the same level as the serving base station 120 among base stations 131, 132, and 133 and requests ranging to the selected target base station. When ranging is successful, the handover is performed.

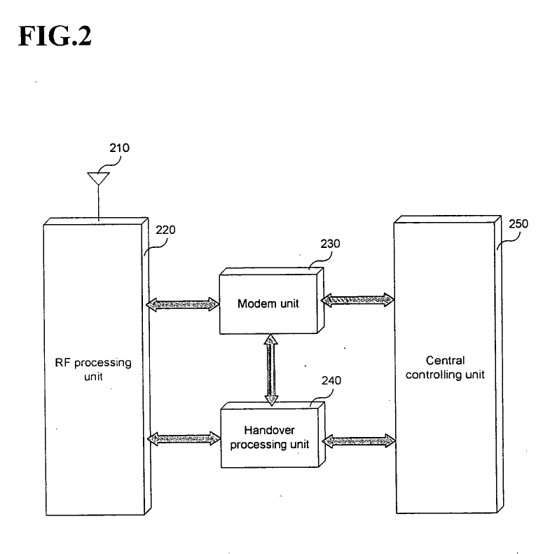

Referring to FIG. 2, the handover reestablishment apparatus according to the exemplary embodiment of the present invention includes a RF (Radio Frequency) processing unit 220, a modem unit 230, a handover processing unit 240, and a central controlling unit 250, and the handover reestablishment apparatus is provided in the serving base station.

RF processing unit 220 transmits/receives a RF signal through an antenna 210 from/to the base station.

Modem unit 230 modulates or demodulates a signal, and handover processing unit 240 reestablishes a handover between the mobile terminal and serving base station when the handover fails.

Central controlling unit 250 transmits information of the neighboring base station and scans the neighboring base station.

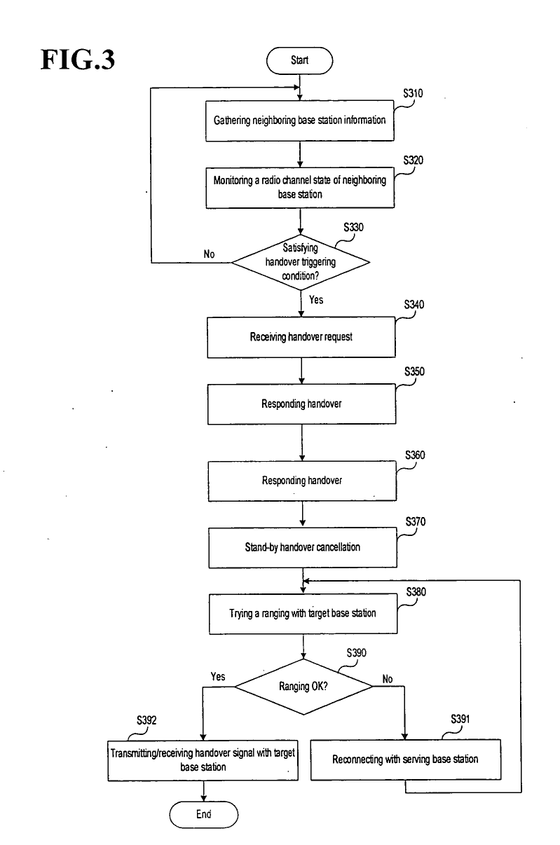

Referring to FIG. 3, the mobile terminal gathers information of the neighboring base stations transmitted though the Neighbor Advertisement (NBR-ADV) message broadcasted from the serving base station in step S310.

The mobile terminal periodically monitors a channel state of the neighboring base station based on the gathered neighboring base station information through the scanning process in step S320.

The mobile terminal checks Carrier to Interference and Noise Ratios (CINRs) indicating channel states of the neighboring base stations and the CINR of the serving base station, and accordingly, determines if the neighboring base stations satisfy a handover trigger condition in step S330.

When the neighboring base stations satisfy the handover trigger condition, the mobile terminal transmits a handover request (HO-REQ) message to the serving base station in step S340.

The HO-REQ message may include a list of the neighboring base stations, i.e., target base stations. When the serving base station receives the HO-REQ message, it checks which neighboring base stations can provide the same service to the mobile terminal by confirming a service capacity of each neighboring base station by using a backbone message. The service capacity includes quality of service (QoS) and radio resource allocation capacity.

The serving base station transmits the handover response (HO-RSP) message including a list of the neighboring base stations capable of performing the handover to the mobile terminal in step S350.

When the mobile terminal receives the HO-RSP message from the serving base station, it determines the neighboring base station having the best probability among the neighboring base stations included in the HO-RSP message as the target base station. The mobile terminal transmits a handover instruction (HO-IND) message to the serving base station so that the serving base station may prepare a cancellation process between the serving base station and the mobile terminal in step S360.

The serving base station receives a backbone message from the target base station and receives the HO-IND message IND from the mobile terminal in step S370. Then, the serving base station waits without performing a handover cancellation process, and the mobile terminal tries ranging to the target base station in step S380.

The serving base station waiting for the handover cancellation receives the handover result (HO-RSLT) message as the backbone message from the target base station and checks the ranging result in step S390. The number of the nominated target base stations confirms the ranging result.

When the handover succeeds according to the ranging result, the serving base station performs a connection cancellation process and the mobile terminal transmits and receives a signal for the handover process to/from the target base station in step S392.

When the handover fails according to the ranging result, the serving base station may not perform a connection cancellation process, but is reconnected with the mobile terminal in step S391.

When the mobile terminal either fails to be connected with the target base station, is again moved to the serving base station, or is reconnected with the serving base station, the connection may be recovered in real-time without any additional signaling process because the connection between the mobile terminal and the serving base station are not cancelled.

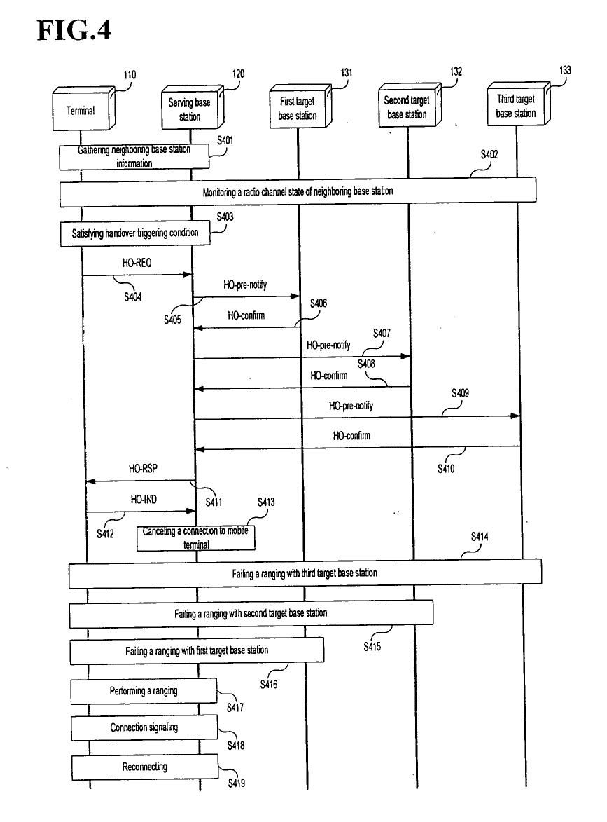

Referring to FIG. 4, before performing the handover function, mobile terminal 110 gathers information of the neighboring base stations, that is, the first to third target base station 131, 132, and 133 through the NBR-ADV message in step S401, and checks channel states of neighboring base stations 131,132, and 133 through the scanning process in step S402.

As a result, mobile terminal 110 becomes a stand-by state for performing a handover process. The mobile terminal 110 compares the channel states of the neighboring base stations 131, 132, and 133 to the channel state of the serving base station 120, and checks if the channel state corresponds to the triggering condition in step S403.

When the channel states of base stations 131, 132, and 133 correspond to the triggering condition of the handover, mobile terminal 110 transmits a HO-REQ message to serving base station 120 in step S404.

Serving base station 120 continuously receives the HO-REQ message negotiated with each neighboring base station 131,132, and 133 included in the nominated list of the HO-REQ message through the backbone message and determines if neighboring base stations 131, 132, and 133 can provide service parameter provided to mobile terminal 110 in steps S405 to S410. For example, serving base station 120 transmits a handover notification (HO-pre-notify) message such as connection parameter and QoS to the first target base station 131 in step S405, and receives a handover confirmation (HO-confirm) message from first target base station 131 in step S406. Such negotiation process is performed for the second target base station 132 and the third target base station 133 in steps S407 to S410.

Accordingly, serving base station 120 confirms which neighboring base stations 131, 132, and 133 can provide the same service as the service level provided to mobile terminal 110 through the above-described negotiation process in steps S405 to S410.

Serving base station 120 transmits the information of the confirmed neighboring base stations 131, 132, and 133 using the HO-RSP message to mobile terminal 110 in step S411.

And then, mobile terminal 110 defines the most appropriate neighboring base station 131, 132, or 133 among the candidates transmitted from serving base station 120 as the target base station, prepares a handover ranging process, and transmits a HO-IND message to serving base station 120 in step S412. Accordingly, mobile terminal 110 starts a handover ranging process with target base station 131,132, or 133.

However, the handover occurs at the cell boundary, and accordingly, interference and noise due to electric wave generated by a plurality of base stations is severe. Thus, the probability of ranging failure is relatively increased at the cell boundary than at the general cell area. In addition, when mobile terminal 110 again moves to the serving base station, status on the handover trigger may be changed.

Serving base station 120 receives the HO-IND message from mobile terminal 110, and then performs a connection cancellation of mobile terminal 120 in step S413.

After mobile terminal 110 cancels a connection with serving base station 120, mobile terminal 110 is connected with the target base station 131, 132, or 133. Since mobile terminal 110 is provided in the cell boundary, cell-boundary mobile terminal 110 has a higher ranging failure probability than a mobile terminal within cell area. In addition, mobile terminal 110 may need to reconnect with the serving base station due to the change of moving direction of mobile terminal 110 and the error of the mobility prediction.

However, during the handover process, since the connection between mobile terminal 110 and serving base station 120 had been canceled, mobile terminal 110 must again perform all the signaling process including the initial ranging.

In more detail, referring to FIG. 4, when mobile terminal 110 fails to perform a ranging to the first to the third target base stations 131, 132, and 133 in steps S414 to S416, that is, the handover is not performed by failing to perform a ranging to all the target base stations 131, 132, and 133, mobile terminal 110 again performs a ranging to serving base station 120 in step S417. In addition, mobile terminal 110 performs a handover connection signaling in step S418, and is reconnected to serving base station 120 in step S419.

Presently, in the communication system such as the portable Internet system, the handover function is based on canceling the connection with the serving base station and being reconnected with the target base station. Such method has no problem when mobile terminal 110 moved to the target base station successfully and performs a handover ranging according to the handover process. However, when the ranging process is not normally performed, mobile terminal 110 must again start a signaling process including the ranging so as to be reconnected with serving base station 120 because the connection between mobile terminal 110 and serving base station 120 was canceled.

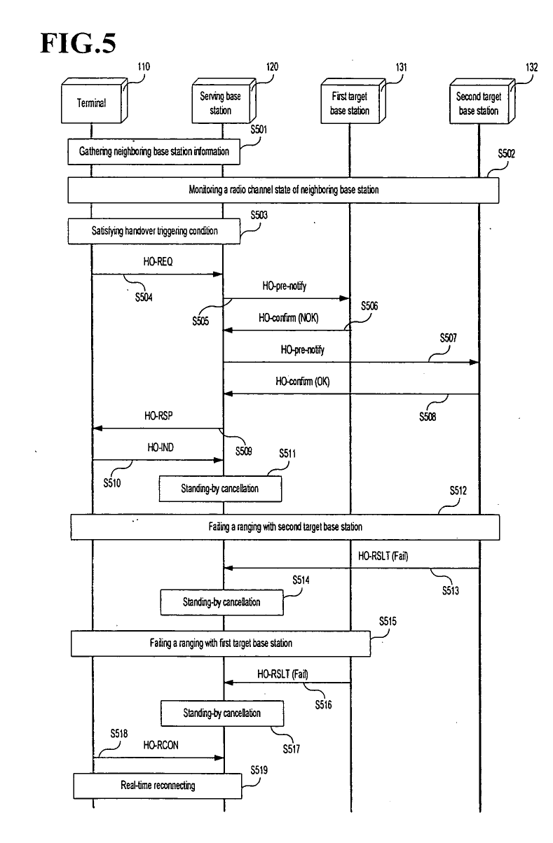

Comparing FIG. 5 to FIG. 4, steps S501 to S510 are similar to steps S410 to S412 of FIG. 4, and thus, are not described in detail. That is, serving base station 120 receives the HO-IND message and prepares a cancellation process between serving base station 120 and mobile terminal 110.

Serving base station 120 receives the HO-IND message and prepares the cancellation process at the cancellation waiting state with mobile terminal 110 in step S511. Mobile terminal 110 defines the base station having the highest handover possibility as the target base station (131 or 132) and performs the handover ranging process thereto.

When mobile terminal 110 fails to perform a ranging process to the second target base station 132 in step S512, the second target base station 132 transmits a HO-RSLT message to serving base station 120 in step S513. When the second target base station 132 fails in a ranging with mobile terminal 110, second target base station 132 transmits a backbone message, that is, the HO-RSLT message including a failure result value to serving base station 120.

When serving base station 120 receives a backbone message from the target base station, it does not performs the handover cancellation process, but maintains the cancellation waiting state because mobile terminal 110 fails to perform a handover with target base station 132.

In addition, Mobile terminal 110 performs the handover ranging process to the first target base station 131 having the higher handover possibility. That is, when mobile terminal 110 fails ranging to the first target base station, it sequentially performs a ranging process to the other neighboring base stations included in the list of the HO-RSP message. When first target base station 131 fails ranging with mobile terminal 110, first target base station 131 transmits the HO-RSLT message including a failure result value to serving base station 120 in step S516.

When serving base station 120 receives the HO-RSLT message from target base station 131, it does not perform the handover cancellation process, and maintains the cancellation waiting state because mobile terminal 110 fails to perform a handover with target base station 131 in step S517.

In order to re-access serving base station 120, mobile terminal 110 receives a handover reconnection (HO-RCON) message in step S518. That is, when mobile terminal 110 fails to perform a ranging process to all the target base stations 131 and 132 included in the list, mobile terminal 110 transmits the HO-RCON message as a new message for requesting a reconnection to serving base station 120.

Since serving base station 120 receives the HO-RCON message during the cancellation waiting state so that it may reconnect with mobile terminal 110 in real-time in step S519.

Accordingly, since serving base station 120 does not perform the cancellation process with mobile terminal 110 and thus all the parameter values related to the given connection are maintained, the reconnection may be performed without additional signaling process.

Serving base station 120 may operate a timer so as to receive a message. That is, serving base station 120 is maintained at the cancellation waiting state when it receives the HO-RSLT message of the handover failure from all targeted base stations 131 and 132.

When serving base station 120 does not receive the HO-RCON message from mobile terminal 110 and the timer ends, serving base station 120 performs the cancellation process with mobile terminal 110 and cancels all the allocated resources.

In addition, when serving base station 120 does not receive the HO-RSLT message as the backbone message from target base stations 131 and 132, it performs the cancellation process according to the error process.

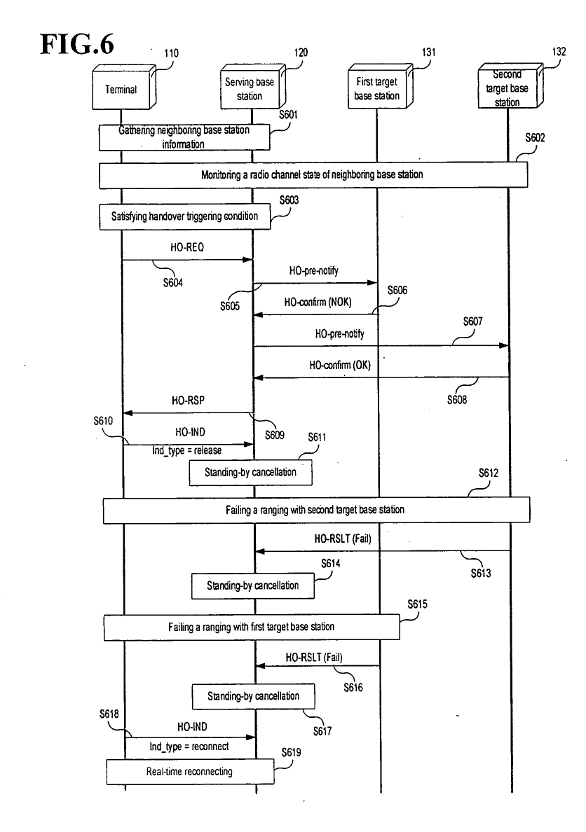

Comparing FIG. 6 to FIG. 5, steps S601 to S619 are substantially the same as steps S501 to S519 of FIG. 5, except for step S618.

Referring to FIG. 6, a new message for requesting a handover reconnection such as a HO-RCON message is not generated. A type “ind_type” for indicating the handover reconnection is added to the parameter of the given HO-IND message so that mobile terminal 120 may transmit the HO_IND message set as the reconnection type to serving base station 120 in step S618.

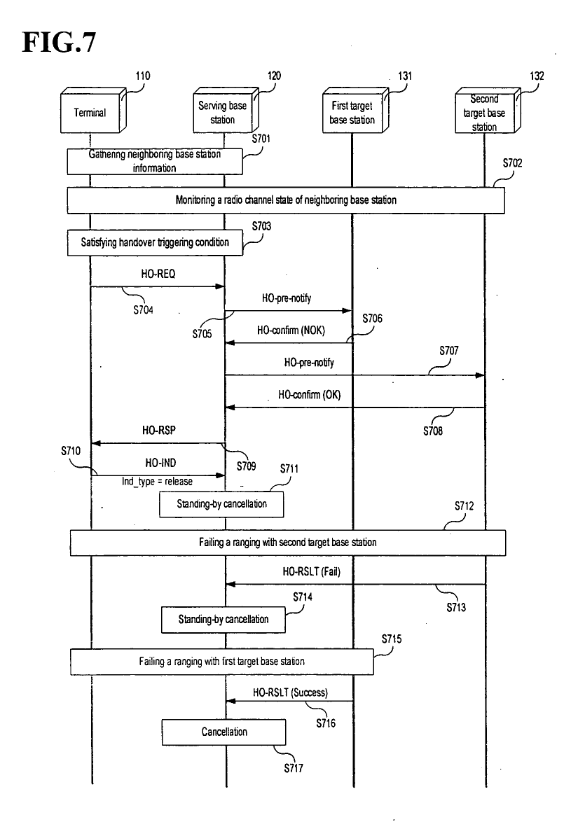

Comparing FIG. 7 to FIG. 6, steps S701 to S714 are substantially the same as steps S601 to S614 of FIG. 6.

Mobile terminal 110 performs a ranging process with each target base stations 131 and 132. When first target base station 131 succeeds in the ranging process in step S715, first target base station 131 transmits a HO-RSLT message having a result value as a success to serving base station 120 in step S716.

When serving base station 120 receives the HO-RSLT message, it performs a cancellation process because first target base station 131 and mobile terminal 110 succeeds in signaling in step S717; downlink traffics, which are stored to be transmitted to mobile terminal 110 during the handover may be forwarded to first target base station 131 through the backbone network.

Serving base station 120 is maintained at the cancellation waiting state without performing the cancellation process before it receives the HO-RSLT message of the handover success from target base station 131 or 132.

According to the exemplary embodiment of the present invention, when serving base station 120 receives the HO-IND message from mobile terminal 110, it does not perform the cancellation process, but is maintained at the waiting state. In this manner, serving base station 120 prepares the cases that mobile terminal 110 fails to perform ranging to target base stations 131 and 132, or it again moves to serving base station 120.

According to the exemplary embodiment of the present invention, target base stations 131 and 132 performed a handover-ranging process transmitting the ranging result through the backbone message to serving base station 120, and accordingly, serving base station 120 may perform processes according to the ranging result.

Accordingly, when serving base station 120 receives the ranging success result from target base station 131 or 132, it cancels the connection to mobile terminal 110. Otherwise, when serving base station 120 receives the ranging failure result, it is maintained at the cancellation waiting state.

The exemplary embodiment of the present invention may cope with an irregular case, which occurs when the handover process is performed in the cell boundary having a bad signal receiving state. In addition, when the mobile terminal fails to perform ranging while it moves to the target cell and performs ranging through the handover process, it may effectively re-access the serving base station. In addition, when the moving direction of the mobile terminal is changed and thus, the mobile terminal enters into the serving area, the mobile terminal may effectively re-access to the serving base station.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for reestablishing a handover with a handover-performing mobile terminal in a serving base station when the mobile terminal fails to perform the handover with a target base station, the method comprising:
receiving a handover request message from the mobile terminal;
waiting without canceling a connection to the mobile terminal when receiving the handover request message; and
performing a reconnection with the mobile terminal when receiving a handover reconnection message from the mobile terminal.

2. The method of claim 1, wherein the serving base station performs real-time reconnection with the mobile terminal without any additional signaling process.

3. The method of claim 1, wherein the reconnection step includes receiving the handover reconnection message from the mobile terminal, and
reconnecting with the mobile terminal while the serving base station having received the handover reconnection message is waiting for the connection cancellation.

4. The method of claim 1, wherein the serving base station performs the reconnection with the mobile terminal using a parameter included in the handover instruction message.

5. The method of claim 4, wherein the handover instruction message includes a reconnect parameter.

6. A method for reestablishing a handover with a handover-performing mobile terminal in a serving base station, the method comprising:
receiving a handover request message from the mobile terminal;
waiting without canceling connection to the mobile terminal when receiving the handover request message;
receiving a backbone message including a ranging result from the target base station which performed a ranging process with the mobile terminal; and,
reconnecting with the mobile terminal when receiving a handover reconnection message from the mobile terminal.

7. The method of claim 6, wherein the receiving of the backbone message comprises canceling the connection to the mobile terminal when the ranging result of the backbone message is a success.

8. The method of claim 6, wherein receiving the backbone message includes maintaining a state for waiting the connection cancellation when the ranging result of the backbone message is a failure.

9. The method of claim 6, further comprising canceling the connection to the mobile terminal when receiving no message for the ranging result from the target base station.

10. The method of claim 6, further comprising canceling the connection to the mobile terminal when receiving no message for the reconnection from the mobile terminal.

11. The method of claim 6, wherein the serving base station performs real-time reconnection with the mobile terminal without any additional signaling process.

12. The method of claim 6, wherein performing the reconnection comprises receiving the handover reestablishment message from the mobile terminal, and reconnecting with the mobile terminal while the serving base station having received the handover reconnection message is waiting for the connection cancellation.

13. The method of claim 6, wherein the serving base station performs the reconnection with the mobile terminal using a parameter included in the handover instruction message.
